(19) United States
(12) Patent Application Publication
(10) Pub. No.: US 2011/0149753 A1
(43) Pub. Date: Jun. 23, 2011

(54) SWITCHING BETWEEN MEDIA BROADCAST STREAMS HAVING VARYING LEVELS OF QUALITY

(75) Inventors: Mark Bapst, South Barrington, IL (US); Stephen M. Verrall, Carlsbad, CA (US)

(73) Assignee: QUALCOMM Incorporated, San Diego, CA (US)

(21) Appl. No.: 12/643,715

(22) Filed: Dec. 21, 2009

(51) Int. Cl. H04L 12/26

(52) U.S. Cl. 370/252

(57) ABSTRACT

In general, this disclosure relates to techniques for switching between media broadcast streams having varying levels of quality. In one example method, a processing pipeline of a communication device processes a first broadcast stream representing a first version of media content. The processing pipeline includes quality checkpoints at which broadcast stream quality may be determined, and receives a second, different broadcast stream that is broadcasted at another data rate. The second broadcast stream represents a second version of the media content of different media quality. The processing pipeline measures a quality of the first broadcast stream and a quality of the second broadcast stream at one or more of the quality checkpoints, and switches the processing from the first broadcast stream to the second broadcast stream if the quality of the second broadcast stream exceeds a defined threshold at one or more of the quality checkpoints.

### TECHNICAL FIELD

This disclosure relates to the processing of multimedia broadcast streams by a communication device.

### BACKGROUND

Some newer communication systems provide for adaptive rate multimedia coder decoders (CODECs) or hierarchical transmission to allow the quality of the received and rendered content to adapt to the communication channel. In good signal conditions, high resolution content can be received and rendered. Unfortunately, most legacy broadcast, unicast and multicast transmission systems support neither adaptive rate CODECs nor hierarchical transmission. As a result, when the signal conditions vary, the received and rendered content does not adapt.

The concept of folding in broadcast communication allows a user to obtain the best available multimedia content given the communication signal within the environment of the user. For example, if a user is stationary and is able to receive a higher bandwidth terrestrial signal on a mobile communication device, the user may be able to watch a digital television program in high-definition format. The communication device may switch manually or automatically from one broadcast stream (e.g., terrestrial stream) to another broadcast stream (e.g., mobile broadcast stream) in order to obtain a more robust, albeit lower resolution, version of the same program.

If a communication device switches between different streams on a frequent basis, the user of the device may perceive choppiness in the rendered output. For example, a user may experience such a result when using a device that frequently switches between streams of different resolution and frame rate, such as between mobile ISDB-T (Integrated Services Digital Broadcasting) 1-segment and terrestrial high-definition format 12-segment streams, or between other forms of mobile and terrestrial broadcast streams.

### SUMMARY

In general, this disclosure relates to techniques for intelligently switching between media broadcast streams broadcasted at different data rates and having varying levels of quality. For example, switching between first and second broadcast streams, which may be broadcast at different frame rates and resolution, would permit a communication device to simultaneously receive and decode the streams, measure the quality of each stream's communication channel, and synchronizing the content during the switchover. In some examples, a communication device may decode and render media content from a first broadcast stream if the quality of the second broadcast stream falls below an acceptable threshold and the quality of the first broadcast stream exceeds a certain threshold. On the other hand, the device may, in certain cases, decode and render the content from the second broadcast stream if the quality of the second broadcast stream exceeds the acceptable threshold.

In one example, a method comprises the following features: processing, within a processing pipeline of a communication device, a first broadcast stream representing a first version of media content, wherein the processing pipeline includes a plurality of quality checkpoints at which broadcast stream quality may be determined; receiving, within the processing pipeline, a second, different broadcast stream that is broadcasted at a different data rate than the first broadcast stream, wherein the second broadcast stream represents a second version of the media content of different media quality than the first version of the media content; measuring, within the processing pipeline, a quality of the first broadcast stream and a quality of the second broadcast stream at one or more of the quality checkpoints; and switching the processing from the first broadcast stream to the second broadcast stream if the quality of the second broadcast stream exceeds a defined threshold at one or more of the quality checkpoints.

In one example, a computer-readable storage medium comprises computer-executable instructions for causing one or more processors to: process, within a processing pipeline, a first broadcast stream representing a first version of media content, wherein the processing pipeline includes a plurality of quality checkpoints at which broadcast stream quality may be determined; receive, within the processing pipeline, a second, different broadcast stream that is broadcasted at a different data rate than the first broadcast stream, wherein the second broadcast stream represents a second version of the media content of different media quality than the first version of the media content; measure, within the processing pipeline, a quality of the first broadcast stream and a quality of the second broadcast stream at one or more of the quality checkpoints; and switch the processing from the first broadcast stream to the second broadcast stream if the quality of the second broadcast stream exceeds a defined threshold at one or more of the quality checkpoints.

In one example, a communication device comprises a processing pipeline comprising one or more processors, wherein the processing pipeline includes a plurality of quality checkpoints at which broadcast stream quality for one or more broadcast streams may be determined. The one or more processors of the processing pipeline are configured to: process a first broadcast stream representing a first version of media content; simultaneously receive a second, different broadcast stream that is broadcasted at a different data rate than the first broadcast stream, wherein the second broadcast stream represents a second version of the media content of different media quality than the first version of the media content; measure a quality of the first broadcast stream and a quality of the second broadcast stream at one or more of the quality checkpoints; and switch the processing from the first broadcast stream to the second broadcast stream if the quality of the second broadcast stream exceeds a defined threshold at one or more of the quality checkpoints.

The techniques described in this disclosure may be implemented in hardware, software, firmware, or any combination thereof. For example, various techniques may be implemented or executed by one or more processors. As used herein, a processor may refer to a microprocessor, an application specific integrated circuit (ASIC), a field programmable gate array (FPGA), a digital signal processor (DSP), or other equivalent integrated or discrete logic circuitry. Software may be executed by one or more processors. Software comprising instructions to execute the techniques may be initially stored in a computer-readable storage medium and loaded and executed by one or more processors. Thus, in various different aspects, hardware or software can automatically, or the user can manually, determine the decision to switch between streams based on quality feedback at a plurality of checkpoints.

Accordingly, this disclosure also contemplates computer-readable storage media comprising instructions to cause a processor to perform any of a variety of techniques as described in this disclosure. In some cases, a computer-readable storage medium may form part of a computer program storage product, which may be sold to manufacturers and/or used in a device. The computer program product may include the computer-readable storage medium, and in some cases, may also include packaging materials.

The details of one or more aspects are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a communication device that is communicatively coupled to multiple broadcast stream sources, where the mobile communication device includes a stream switchover module that is configured to switch between different streams provided by the broadcast stream sources.

FIG. 2 is a block diagram illustrating an example of a mobile communication device that may be communicatively coupled to multiple broadcast stream sources.

FIG. 3 is a block diagram illustrating another example of a mobile communication device that may be communicatively coupled to multiple broadcast stream sources.

FIG. 4 is a flow diagram illustrating an example of a method that may be performed by a mobile communication device to switch between broadcast streams having varying levels of quality.

FIG. 5 is a state diagram illustrating an example of state transitions based upon events that determine whether a mobile communication device will render content from a mobile or a terrestrial broadcast stream, which comprise streams having different frame rates and/or resolution.

FIG. 6 is a state diagram illustrating an example of state transitions based upon events that determine whether a mobile communication device will switch from rendering content contained in a terrestrial broadcast stream to, instead, rendering content contained in a mobile broadcast stream.

FIG. 7 is a state diagram illustrating an example of state transitions based upon events that determine whether a mobile communication device will switch from rendering content contained in a mobile broadcast stream to, instead, rendering content contained in a terrestrial broadcast stream.

### DETAILED DESCRIPTION

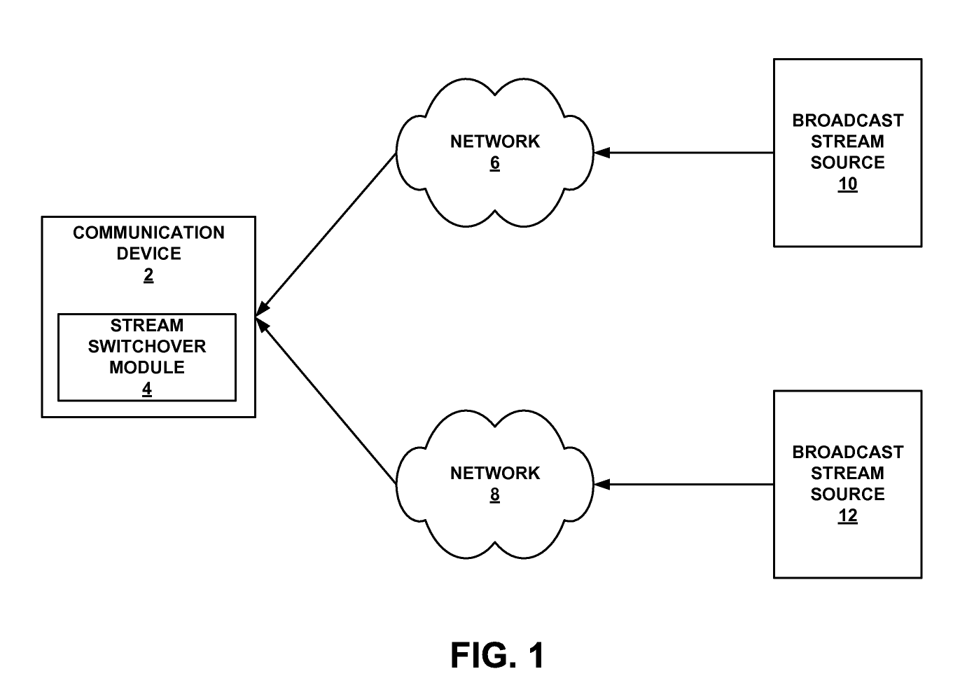

FIG. 1 is a block diagram illustrating an example of a communication device 2 that is communicatively coupled to multiple broadcast stream sources 10 and 12, where communication device 2 includes a stream switchover module 4 that is configured to switch between different streams provided by broadcast stream sources 10 and 12. In this example, each of broadcast stream sources 10 and 12 are capable of broadcasting media content over one or more broadcast streams within one or more frequency bands of a broadcast spectrum for a particular broadcast format via respective networks 6 and 8. The media content may include audio and/or video data.

In some examples, the broadcast format may comprise any form of digital broadcast format, such as the Advanced Television Systems Committee (ATSC) format, the Integrated Services Digital Broadcasting (ISDB) format, or the Digital Video Broadcasting (DVB) format, to name only a few. Networks 6 and 8 may comprise any form of wireless and/or broadcast network. In some examples, broadcast stream source 10 and/or broadcast stream source 12 may comprise a satellite-based source. In this disclosure, the term “broadcast” is broadly defined to include any transmission of media data from one source device to one or to multiple destination devices (e.g., in unicast or multicast networks).

In one example, broadcast stream source 10 broadcasts media data at a different data (e.g., frame) rate than broadcast stream source 12. For example, broadcast stream source 10 may broadcast data at a lower data rate than broadcast stream source 12. However, broadcast stream source 10 may broadcast the same media content as broadcast stream source 12, albeit at a different data rate. For example, broadcast stream source 10 and broadcast stream source 12 may each broadcast the same television program or other media content at substantially the same time. In one scenario, broadcast stream source 10 may broadcast a high-definition version of a television program, while broadcast stream source 12 may broadcast a lower-definition version of the same television program. In this example, the lower data rate stream may be transmitted using a simpler modulation scheme such as Quadrature Phase Shift Keying (QPSK), whereas the higher data rate stream may be transmitted using a more complex modulation scheme such as 64 Quadrature Amplitude Modulation (64 QAM), rendering it more difficult to receive in adverse signal conditions.

Communication device 2 may comprise a stand-alone device or may be part of a larger system. For example, communication device 2 may comprise, or be part of, a wireless media communication device (such as a wireless mobile handset), a digital TV, an automotive TV player, a video telephone, a digital multimedia player, a personal digital assistant (PDA), a video game console, a personal computer or laptop device, or other video device. Communication device 2 may also be included within one or more integrated circuits, or chips, which may be used in some or all of the devices described above.

Communication device 2 may execute or otherwise implement functionality to receive and process media data that is broadcasted from broadcast stream source 10 via network 6 and/or from broadcast stream source 12 via network 8, and may implement a data processing pipeline when processing such data. The processing pipeline may include multiple quality checkpoints at which a broadcast stream quality may be determined.

For example, communication device 2 may implement a processing pipeline to process a first broadcast stream representing a first version of media content from broadcast stream source 10. Communication device 2 may also implement the processing pipeline to receive a second, different broadcast stream that is broadcasted from broadcast stream source 12 at a different data rate than the first broadcast stream, where the second broadcast stream represents a second version of the media content (e.g., television show or broadcast) of different media quality (e.g., different resolution, different frame rate, different data rate).

Communication device 2 may measure a quality of the first broadcast stream and a quality of the second broadcast stream at one or more of the quality checkpoints. Communication device 2 may render the higher-resolution broadcast stream regardless of the quality of the lower resolution broadcast stream provided the received quality of the higher-resolution broadcast stream is above a defined quality threshold. Communication device 2 may then switch the processing from the first broadcast stream to the second broadcast stream if the quality of the second broadcast stream is above a defined threshold. The second broadcast stream may be broadcasted at a higher data rate and/or represent content of higher resolution than the first broadcast stream.

In some cases, communication device 2 may switch the processing from the first broadcast stream to the second broadcast stream if the quality of the first broadcast stream is below a defined threshold and if the quality of the second broadcast stream is above a defined threshold. As a result, stream switchover module 4 allows communication device 2 to intelligently switch between media (e.g., multimedia) broadcast streams broadcasted at different data rates and having varying levels of quality. In some instances, stream switchover module 4 is capable of synchronizing the content during the switchover, as will be described in more detail below.

In one scenario, broadcast stream source 10 may broadcast a high-definition version of a television program, while broadcast stream source 12 may broadcast a lower-definition version of a television program. Communication device 2 may comprise a mobile device capable of displaying both high- and low-definition television program content. If a user of communication device 2 is located in a certain area with adequate signal strength, communication device 2 may determine that the quality of the broadcast stream from broadcast stream source 10 is higher than a defined, acceptable threshold, and may therefore display the high-definition version of the program.

If, however, the user moves to a different area where the signal strength becomes weaker (e.g., due to environmental conditions, terrain, or distance from broadcast towers), communication device 2 may determine that the quality of the broadcast stream from broadcast stream source 10 is lower than the acceptable threshold, but that the quality of the broadcast stream from broadcast stream source 12 is above a defined threshold. In this case, stream switchover module 4 may switch the processing of the broadcast stream from broadcast stream source 12, and display the lower-definition version of the television program to the user. In this example scenario, stream switchover module 4 allows communication device 2 to intelligently switch between a high-definition and a lower-definition version of the same program.

In some cases, the streams broadcast by broadcast stream sources 10 and 12 can also be multiplexed into the same channel, such as is the case with Integrated Services Digital Broadcasting Terrestrial (ISDB-T) and some Digital Video Broadcasting Terrestrial/Handheld (DVB-T/DVB-H) hierarchical networks. Broadcast stream sources 10 and 12, in some examples, may each comprise a land-based or satellite-based source, and networks 6 and 8 may comprise wireless networks.

In general, stream switchover module 4 allows communication device 2 to intelligently switch between media broadcast streams broadcasted at different data rates and having varying levels of quality. For example, stream switchover module 4 may switch between streams that may be broadcast at different frame rates from broadcast stream source 10 and broadcast stream source 12. As a result, communication device 2, when using stream switchover module 4, may provide the ability to simultaneously receive and decode the different streams provided by broadcast stream sources 10 and 12, measure the quality of each stream, and possibly synchronize the content during the switchover, as described on more detail below.

In some cases, content provided by a stream having higher resolution may be favored in case of comparable qualities between two streams. Communication device 2 may monitor various stream quality metrics at different points in the receive pipeline, such as FRERR (relative frame loss), TSERR (transport stream error), RSSI (received signal strength indicator), BER (bit error rate), and MFER (MFEC Error Rate), to name only a few non-limiting examples, in order to determine when to switch between the two streams, as will be described in more detail below.

The network latency that exists between different broadcast streams that represent common content (but with different levels of resolution) may often be a fixed and constant time for a given broadcast (e.g., television show). In some examples, this time can be recorded by communication device 22, and a time-shift buffer can be used to switch to the appropriate (approximate) frame time to minimize the switching nuisance that may otherwise be perceived by the user, as described further below.

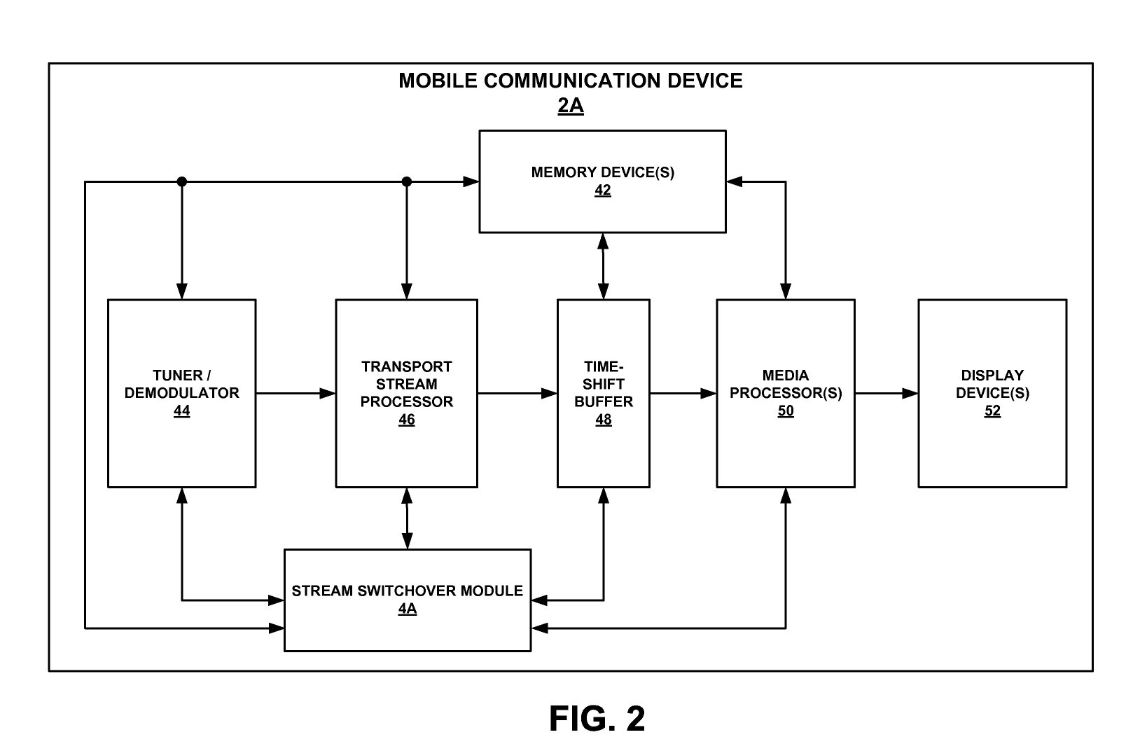

FIG. 2 is a block diagram illustrating an example of a mobile communication device 2A that may be communicatively coupled to multiple broadcast stream sources. Mobile communication device 2A is one example of communication device 2 shown in FIG. 1. Thus, in some cases, mobile communication device 2A may be coupled to broadcast stream sources 10 and 12 via respective networks 6 and 8.

As shown in FIG. 2, mobile communication device 2A includes one or more memory devices 42, a tuner/demodulator 44, a transport stream processor 46, a time-shift buffer 48, one or more media processors 50, one or more display devices 52, and a stream switchover module 4A. Stream switchover module 4A may comprise one example of stream switchover module 4 shown in FIG. 1.

Memory devices 42 may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media, or any other form of computer-readable storage medium. Each of tuner/demodulator 44, transport stream processor 46, time-shift buffer 48, media processors 50, and stream switchover module 4A may access memory devices 42 for storage and/or retrieval of information.

Tuner/demodulator 44 includes tuning and/or demodulation functionality. The broadcast streams received by mobile communication device 2A may be broadcast in one or more frequency bands of a particular broadcast spectrum. Tuner/demodulator 44 may tune in to the one or more frequency bands of the broadcast streams, and may also demodulate the stream data. Tuner/demodulator 44 may be implemented in or by one or more processors, or may also be executed by one or more processors, such as a central processing unit.

For example, tuner/demodulator 44 may provide the demodulated stream data to transport stream processor. The demodulated stream data for each received broadcast stream may be provided to transport stream processor 46 for further processing. Transport stream processor 46 may perform various transport-level operations on the stream data for the broadcast streams. For example, transport stream processor 46 may perform certain security or encryption functions with respect to the received broadcast streams. Typically, the received broadcast streams will contain multiplexed data (e.g., audio data, video data, metadata, or other information, such as Picture-in-Picture information) within the stream data.

As a result, transport stream processor 46 may also perform various demultiplexing operations with respect to the stream data, and provide one or more demultiplexed elementary streams to time-shift buffer 48. Each elementary stream includes data of a particular type, such as audio or video data. Thus, for each received broadcast stream, transport stream processor 46 may provide one or more demultiplexed elementary streams to time-shift buffer 48.

In many cases, network latencies that exist between stream content received from different broadcast sources that broadcast different versions of the same content (e.g., different resolution broadcasts of the same television program) are substantially fixed and constant for given broadcast streams. For example, the network latency that exists between a stream containing high-definition television content and a stream containing lower-definition television content (e.g., for the same program) may be a fairly fixed or constant time. (For example, the latency of the ISDB-T 12-segment terrestrial network may, in some cases, be about three seconds longer than the 1-segment mobile network.) This time can be compensated by time-shift buffer 48, which may, in some cases, comprise a non-volatile storage area.

Time-shift buffer 48 can be used by stream switchover module 4A to switch to the appropriate (approximate) frame time, based upon the time information stored in time-shift buffer 48, to minimize any potential switching nuisance that may otherwise be perceived by the user (e.g., switching between a high-definition version and a lower-definition version of a program). In one aspect, time-shift buffer 48 may use various time-shift values associated with different broadcast sources or broadcast stream types. Stream switchover module 4A may select or use a particular time-shift value (e.g., time value) for time-shift buffer 48 based upon the specific broadcast stream sources that broadcast the stream data and/or the type of received data. Stream switchover module 4A may be implemented in or by one or more processors, or may also be executed by one or more processors, such as a central processing unit.

For example, when switching from a first stream to a second stream that has two seconds lower system or network latency, stream switchover module 4A switches to the second stream to be rendered at a point in time-shift buffer 48, which is delayed two seconds to align with the incoming first stream. When switching back to the content of the first stream, stream switchover module 4A switches to the first stream without any delay in time-shift buffer 48. The two-second latency value in this example may remain substantially constant with respect to the first and second streams, and may be stored in a non-volatile memory (e.g., memory within memory devices 42).

The output of time-shift buffer 48, which may comprise one or more demultiplexed elementary streams, is provided to media processors 50. Media processors 50 may include one or more of a video processor, an audio processor, a graphics processor, and a display processor. Typically, each elementary stream received from time-shift buffer 48 may include data of a particular type (e.g., video, audio, metadata) that may be processed by an appropriate one of media processors 50. Media processors 50 provide processed output to one or more display devices 52. In some examples, when device 2A may be configured to operate in a PVR (personal video recorder) mode, any of tuner/demodulator 44, transport stream processor 46, time-shift buffer 48, and/or media processors 50 may record or store the processed output, including stream data for the first broadcast stream and/or the second broadcast stream, to memory devices 42 for subsequent use or retrieval.

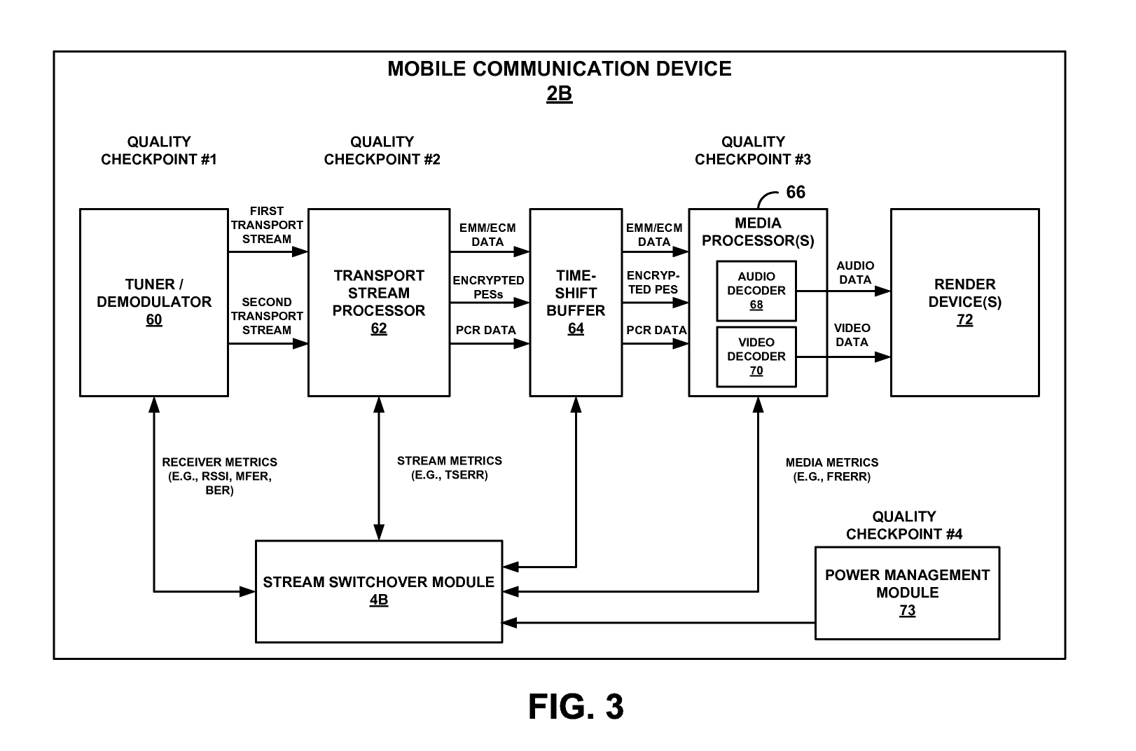

As shown in FIG. 2, stream switchover module 4A is coupled to tuner/demodulator 44, transport stream processor 46, and media processors 50. Stream switchover module 4A is capable of receiving and/or processing one or more measured metrics, including quality and/or performance metrics, based upon its communication with each of tuner/demodulator 44, transport stream processor 46, and media processors 50, as will be described in more detail below in reference to FIG. 3. Based upon these measured metrics, stream switchover module 4A may determine whether to switch from the processing of a first broadcast stream to the processing of a second broadcast stream having a different data rate, where the second broadcast stream may include the same media content as the first broadcast stream.

FIG. 3 is a block diagram illustrating an example of a mobile communication device 2B that may be communicatively coupled to multiple broadcast stream sources. Mobile communication device 2B is one example of mobile communication device 2A shown in FIG. 2. Similar to mobile communication device 2A, mobile communication device 2B includes a tuner/demodulator 60, a transport stream processor 62, a time-shift buffer 64, one or more media processors 66, a stream switchover module 4B, a power management module 73, and one or more render devices 72, which may comprise one or more display devices.

Mobile communication device 2B may utilize a processing pipeline to process stream data from received broadcast streams, such as those that may be broadcast from different broadcast stream sources (e.g., broadcast stream sources 10 and 12 shown in FIG. 1). In FIG. 3, the processing pipeline may comprise tuner/demodulator 60, transport stream processor 62, time-shift buffer 64, a central processing unit CPU (not shown), media processors 66, stream switchover module 4B, power management module 73, and render devices 72. In FIG. 2, the processing pipeline may comprise memory 42, stream switchover module 4A, tuner/demodulator 44, transport stream processor 46, time-shift buffer 48, media processors 50, and display devices 52.

The processing pipeline may include multiple quality checkpoints at which a broadcast stream quality may be determined for one or more of the broadcast streams. FIG. 3 shows an example of four such quality checkpoints within the processing pipeline: tuner/demodulator 60, transport stream processor 62, power management module 73, and media processors 66. Each of the quality checkpoints may provide information that may be used by stream switchover module 4B in measuring or otherwise determining a quality of a particular broadcast stream, as will be described in more detail below. For example, the quality checkpoints may generate certain metrics (e.g., performance or quality metrics) that may be provided to stream switchover module 4B. In some cases, stream switchover module 4B may calculate the metrics based upon certain data provided by the quality checkpoints.

For instance, tuner/demodulator 60 may provide various receiver-based metrics to stream switchover module 4B indicating a relative receive quality of received streams (e.g., streams broadcast at different data rates and/or representing content at different media quality levels). For example, tuner/demodulator 60 may provide receiver metrics for a received signal strength indicator (RSSI), MFEC error rate (MFER), and bit error rate (BER) for each of the received broadcast streams. Upon receipt of these receiver metrics, stream switchover module 4B is capable of calculating a receive quality of each received broadcast stream.

RSSI provides an indication of received signal strength. BER indicates the bit error rate irrespective of content format (i.e., a higher BER can be tolerated more easily in less important content). MFEC indicates the final error rate at the last stage of data recovery (Forward error correction) in tuner/demodulator 60.

Tuner/demodulator 60 may provide the broadcast streams (e.g., in demodulated form) to transport stream processor 62. In the example of FIG. 3, it is assumed that tuner/demodulator 60 has received a first broadcast stream and a second broadcast stream, where one stream is broadcast at a different frame rate than the other stream, and where the streams represent content at different levels of resolution. For example, one stream may be broadcast at a higher frame rate and/or represent content at a higher resolution than the other stream.

Upon providing receiver-based metrics for each of these streams to stream switchover module 4B, tuner/demodulator 60 provides one or both of the streams to transport stream processor 62 for further processing. (In FIG. 3, these streams are labeled “first transport stream” and “second transport stream”.) Typically, the streams provided to transport stream processor include multiplexed data. For example, the first transport stream and the second transport stream may each include multiplexed data (e.g., video, audio, and/or metadata).

Transport stream processor 62 comprises a second checkpoint in the example of FIG. 3. Transport stream processor 62 may provide certain stream or transport-level metrics to stream switchover module 4B. For example, transport stream processor 62 may provide a transport stream error rate (TSERR) metric for each of the received transport streams, which may provide any indications of packet-level errors.

Transport stream processor 62 may demultiplex the transport streams into packetized elementary streams (PESs), where each PES includes media data of a particular type (e.g., audio, video data). The PESs may also include metadata (e.g., textual, graphics, or other data that may be provided with the media data upon output). Transport stream processor 62 may encrypt the PESs for each received stream, and provide the encrypted PESs to time-shift buffer 64.

Transport stream processor 62 may also provide programmable clock reference (PCR) and entitlement management and control messages (EMM/ECM) for one or both streams to time-shift buffer 64. Each PCR may be used to synchronize certain content within a given stream, and the EMM/ECM messages are used for security purposes. Errors in the received EMM/ECM messages can, in some cases, make it temporarily impossible to decrypt and render the incoming broadcast stream.

Similar to time-shift buffer 48 shown in FIG. 2, time-shift buffer 64 can be used by stream switchover module 4B to switch to the appropriate (approximate) frame time, based upon the time information stored in time-shift buffer 64, to minimize any potential switching nuisance that may otherwise be perceived by the user (e.g., switching between a high-definition version of content in one stream and a lower-definition version of the same content in a different stream). The use of time-shift buffer 64 allows switchover module 4B to provide a programmable form of hysteresis, as outlined in more detail below, that may help avoid too frequent switching between the streams.

Media processor 66 comprises another quality checkpoint. Media processors 66 receive the information provided by time-shift buffer 64 and process the media data for output to render devices 72. In the example of FIG. 3, media processors 66 include an audio decoder 68 to decode audio data contained in one or more of the audio PESs, and also include a video decoder 70 to decode video data contained in one or more of the video PESs. Audio decoder 68 provides audio output data to render devices 72, while video decoder 70 provides video output data to render devices 72.

Media processors 66 may also provide certain media metric information to stream switchover module 4B. For example, media processors 66 may provide frame loss error rate (FRERR) or Block Error (BLERR) information to stream switchover module 4B, indicating a relative number of frames or macroblocks that may have been lost during processing.

Power management module 73 may comprise yet another quality checkpoint in the pipeline. Power management module 73 may be capable of monitoring a battery or other power level within mobile communication device 2B, and can provide power/battery level or other power-related metric information to stream switchover module 4B. In some cases, if the battery or power level begins to decrease or go low, stream switchover module 4B may determine to switch to the stream that is broadcast at a lower data rate and/or represents content of lower resolution in order to conserve power, assuming a quality of the stream exceeds a defined quality threshold.

Stream switchover module 4B may utilize the metric information provided by the various quality checkpoints (tuner/demodulator 60, transport stream processor 62, media processors 66) to determine whether to switch processing between the mobile stream and the broadcast stream, and where in the processing pipeline to perform various switching operations. Switching streams in the back-end of the pipeline (e.g., near media processors 66) may provide the fastest swap of rendered content, but it may consume more power given that both the streams are decoded prior to switching. Switching streams in the front-end of the pipeline (e.g., near tuner/demodulator 60) may provide a lower power profile, but may result in a longer swap time between streams (and subsequently provide a worse user experience).

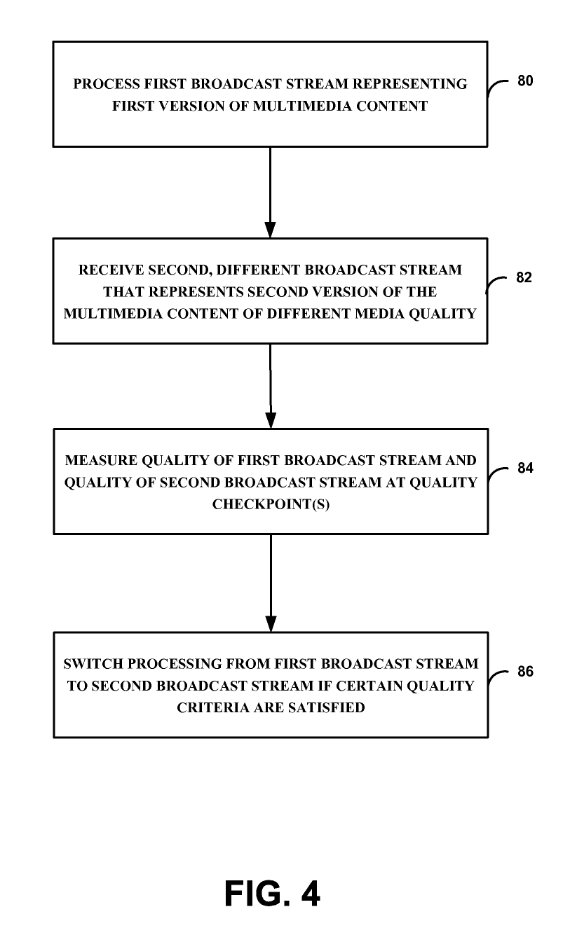

Stream switchover module 4B is capable of measuring or otherwise determining a quality of a first broadcast stream and a quality of a second broadcast stream at one or more of the quality checkpoints (tuner/demodulator 60, transport stream processor 62, power management module 73, media processors 66) identified in FIG. 3 based upon the received metrics from these checkpoints (e.g., RSSI, MFER, BER, TSERR, FRERR). Stream switchover module 4B is then capable of switching the processing between streams based upon the measured qualities of the streams. For example, stream switchover module 4B may switch the processing from a first broadcast stream to a second broadcast stream if the quality of the first broadcast stream is below a first threshold and if the quality of the second broadcast stream is above a second threshold. Examples of such threshold checking are described in more detail below in reference to FIGS. 4-7.

FIG. 4 is a flow diagram illustrating an example of a method that may be performed by a communication device (e.g., one or more of the mobile communication devices shown in FIGS. 1-3) to switch between broadcast streams having varying levels of quality. The communication device may process, within a processing pipeline of the communication device, a first broadcast stream representing a first version of media content (e.g., television program), wherein the processing pipeline includes a plurality of quality checkpoints at which a broadcast stream quality may be determined (80). For instance, the communication device may utilize quality checkpoints such as those shown in FIG. 3, where tuner/demodulator 60 functions as a first checkpoint, transport stream processor 62 functions as a second checkpoint, and media processors 66 function as a third checkpoint.

The communication device may receive, within the processing pipeline, a second, different broadcast stream that is broadcasted at a different data rate than the first broadcast stream, wherein the second broadcast stream represents a second version of the media content of different media quality (e.g., different resolution, different frame rate, different data rate) than the first version of the media content (82). The communication device may measure, within the processing pipeline, a quality of the first broadcast stream and a quality of the second broadcast stream at one or more of the quality checkpoints (84). The communication device may then switch the processing from the first broadcast stream to the second broadcast stream if the quality of the second broadcast stream exceeds a defined threshold at one or more of the quality checkpoints (86). The second version of the media content may, in some cases, have one or more of higher resolution, frame rate, or data rate than the first version of the media content.

In some cases, the communication device may process one or both of the first and second broadcast streams at multiple ones of the quality checkpoints. The device may then measure the qualities of one or both of the first and second broadcast streams at the multiple ones of the quality checkpoints. In some cases, the communication device may demodulate the first and second broadcast streams (e.g., using tuner/demodulator 44 of FIG. 2 or tuner/demodulator 60 of FIG. 3), and measure a quality of the demodulated first and second broadcast streams using one or more receiver-based metrics (e.g. RSSI, MFER, BER) at one of the quality checkpoints. In some cases, the communication device may utilize a transport-level metric (e.g., TSERR) when measuring or determining stream quality values.

The communication device may demultiplex the received first and/or second broadcast streams in some instances. The device, for example, may utilize a transport stream processor (e.g., transport stream processor 46 of FIG. 2 or transport stream processor 62 of FIG. 3) to demultiplex demodulated versions of the first and/or second broadcast streams. The device may then measure qualities of one or more of the demultiplexed broadcast streams at one of the quality checkpoints. For example, the device may measure one or more stream metrics (e.g., TSERR).

The communication device may decode the demultiplexed broadcast stream(s) (e.g., using audio decoder 68 and/or video decoder 70 shown in FIG. 3. The communication device may measure a quality of the decoded broadcast stream(s) using one or more metrics (e.g., FRERR) at another one of the quality checkpoints.

In some cases, prior to switching the processing from the first broadcast stream to the second broadcast stream, the communication device may decode, within the processing pipeline, the first version of the media content represented by the first broadcast stream. For example, the communication device may use one or more decoders (e.g., audio decoder 68 and/or video decoder 70 shown in FIG. 3) to decode the media content. In addition, the communication device may render the first version of the media content (e.g., for purposes of display on one of devices 52 or 72, shown in FIGS. 2 and 3). In some examples, any of tuner/demodulator 60, transport stream processor 62, time-shift buffer 64, and/or media processors 66 may record or store its processed output to one or more memory devices (e.g., memory devices 42 shown in FIG. 2) for subsequent use or retrieval.

After the processing has switched from the first broadcast stream to the second broadcast stream, the communication device may render the second version of the media content represented by the second broadcast stream. In some cases, the communication device may even optionally disable demultiplexing and/or decoding of the first version of the media content represented by the first broadcast stream after the processing has switched to the second broadcast stream in order to save power. The communication device may perform such disabling functionality if the quality of the first broadcast stream falls significantly below the first threshold. However, the device may only optionally perform such disabling functionality in certain cases.

In some cases, the communication device may switch from the first version of the media content to the second version of the media content and incur a network latency that exists between the first broadcast stream and the second broadcast stream. To compensate for this latency between content, the device may receive (i.e. via the broadcast network) or pre-store a time value (e.g., an estimated value) corresponding to the network latency (e.g., within a non-volatile memory), and switch from the first version of the media content to the second version of the media content while compensating for network latency using a time-shift buffer (e.g., time-shift buffer 48 shown in FIG. 2 or time-shift buffer 64 shown in FIG. 3) when performing the switch, such as, for example, to present a user with substantially continuous content. For example, the device may utilize time shifting to compensate for the network latency when performing the switch.

In some cases, the device may measure qualities of the first broadcast stream and qualities of the second broadcast stream at one or more of the quality checkpoints to generate a set of quality metrics for the first broadcast stream and the second broadcast stream. The device may provide the set of quality metrics as input to a stream switchover module (e.g., stream switchover module 4A of FIG. 2 or stream switchover module 4B of FIG. 3), where switching the processing from the first broadcast stream to the second broadcast stream may include using the set of quality metrics by the stream switchover module to determine whether to switch the processing either automatically or under guidance of a user of the device.

As described previously, the communication device may measure the quality of the first broadcast stream and the quality of the second broadcast stream by determining quality metrics at one or more of the quality checkpoints. The communication device may, in some cases, use at least one different quality metric at each one of the quality checkpoints.

For example, as shown in the example of FIG. 3, tuner/demodulator 60, which comprises a first quality checkpoint, may provide one or more receiver-based metrics (e.g., RSSI, MFER, BER) to stream switchover module 4B. Transport stream processor 62, which comprises a second quality checkpoint, may provide one or more stream or transport level metrics (e.g., TSERR) to stream switchover module 4B. And, media processors 66, which comprise a third quality checkpoint, may provide one or more media or frame-level metrics (e.g., FRERR) to stream switchover module 4B.

Based upon the metrics from the different checkpoints, stream switchover module 4B may switch the processing from the first broadcast stream to the second broadcast stream if the quality of the first broadcast stream is below a defined threshold and if the quality of the second broadcast stream exceeds a defined threshold at each one of the quality checkpoints. Thus, in this example, stream switchover module 4B may wait to switch the processing until the quality of the second broadcast stream has exceeded a certain threshold value at each of the multiple quality checkpoints. In so doing, stream switchover module 4B may provide a form of hysteresis or control to avoid frequent switching between streams.

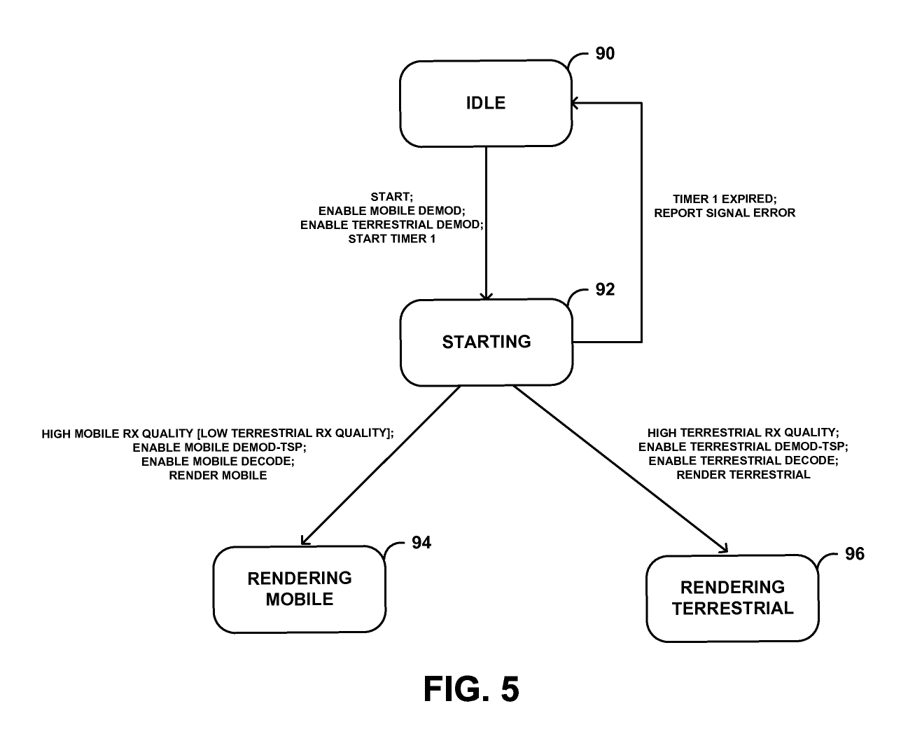

FIG. 5 is a state diagram illustrating an example of state transitions based upon events that determine whether a mobile communication device (e.g., any of the communication devices shown in FIGS. 1-3) will render content from a mobile or a terrestrial broadcast stream. The state diagram of FIG. 5 provides an example of how a mobile communication device may initially determine (e.g., upon startup or when the device receives the initial data packets for mobile and terrestrial broadcast streams) whether to render a mobile broadcast stream or a terrestrial broadcast stream. In many cases, the mobile and terrestrial streams may each be wireless streams of data that represent content of different media quality. For example, the terrestrial stream may represent content of higher quality (e.g., frame rate, data rate, resolution) than that of the mobile stream.

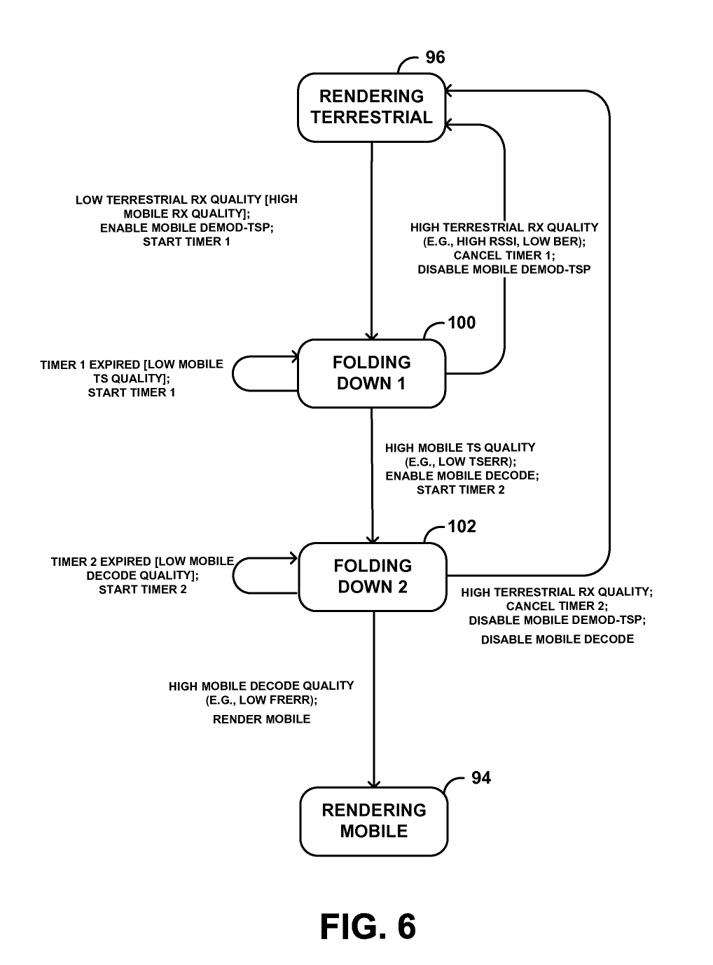

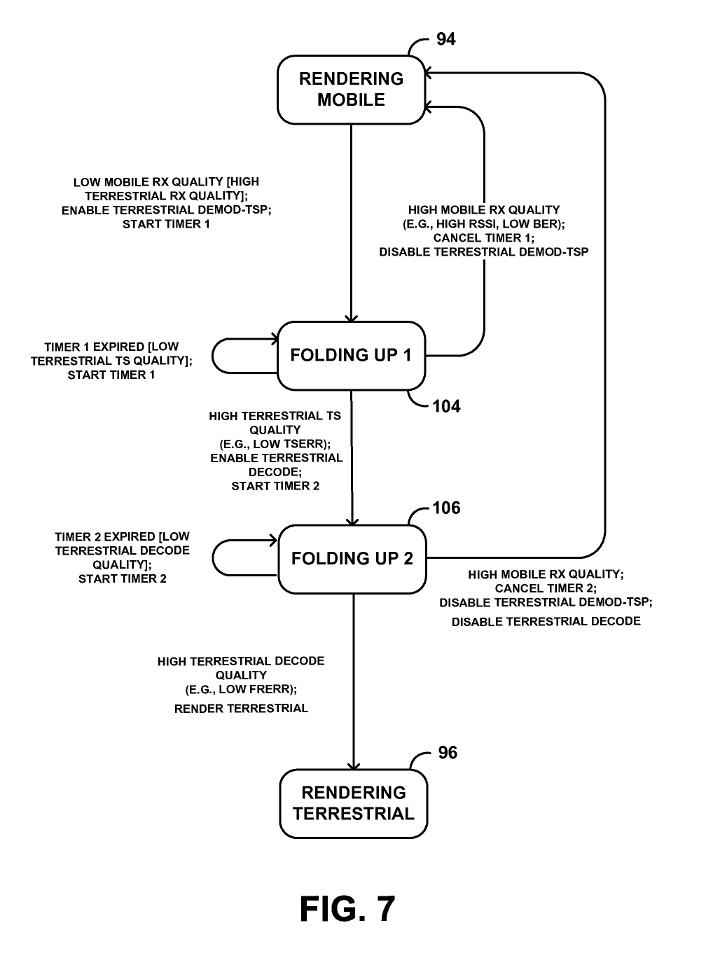

In the example of FIG. 5, as well as in the examples of FIGS. 6-7, reference is made to mobile and terrestrial broadcast streams for purposes of illustration only. In these figures, the terrestrial stream is assumed to be broadcasted at a higher frame rate and/or to represent content of higher resolution than the mobile stream. However, in general, the techniques and operations presented in FIGS. 5-7 may be implemented during the processing of any first broadcast stream and second broadcast stream, where the first broadcast stream is broadcasted at a higher data rate and/or represents content of higher resolution than the second broadcast stream.

For example, the mobile communication device may start in an idle state 90. The mobile communication device may then receive a mobile broadcast stream and a terrestrial broadcast stream. The terrestrial broadcast stream may broadcast at a higher data rate (e.g., frame rate) than the mobile broadcast stream. However, the terrestrial and mobile broadcast streams may include or represent the same media content (e.g., television program).

Upon receipt of the streams, the mobile communication device may enable demodulation functionality for both the received mobile and terrestrial streams. For example, the device may enable tuner/demodulator 60, shown in FIG. 3, allowing tuner/demodulator 60 to demodulate the received mobile broadcast stream and the received terrestrial broadcast stream. The mobile communication device may also start a timer (“Timer 1” as shown in FIG. 5), and move into a new starting state 92. The timer is used to check for changes in signal quality during processing of the received streams. The mobile communication device may expect to process at least one stream with a determined level of quality prior to expiration of the timer. (The value of the timer may be preconfigured within the device, but may also comprise a programmable timer value stored within memory, e.g., within memory devices 42 shown in FIG. 2.)

If the timer expires prior to the mobile communication device determining that either the received mobile or terrestrial stream has a signal quality level that exceeds a defined threshold, the device may report or generate a signal error message (which may be displayed to a user of the device) and return to the idle state 90, in which case the device may wait to receive new or subsequent data streams. The mobile communication device may make such a determination based upon one or more receiver metrics. For example, as shown in FIG. 3, the device may analyze various receiver metrics provided by tuner/demodulator 60, such as RSSI, MFER, and BER when determining whether a signal quality of either the mobile broadcast stream or the terrestrial broadcast stream has reached or exceeded a defined threshold.

If the mobile communication device determines that the signal quality of the terrestrial stream exceeds a defined threshold value, and therefore that the received terrestrial stream is of high quality, the device may determine to begin rendering content from the terrestrial stream (in state 96). In doing so, the device may enable functionality to perform transport-level operations on the demodulated terrestrial stream, which may comprise a terrestrial transport stream. (For example, the device may utilize a transport stream processor, such as shown in the examples of FIGS. 2-3, to process the terrestrial transport stream.) The device may also enable functionality to decode the terrestrial content after the terrestrial transport stream has been processed by the transport stream processor to generate one or more elementary streams. For example, the device may utilize an audio decoder and/or video decoder (such as shown in the example of FIG. 3) to decode the terrestrial content.

If the mobile communication device, however, determines that the signal quality of the terrestrial stream falls below a defined threshold value, but that the signal quality of the mobile stream exceeds a defined threshold value (indicating that the received mobile stream is of high quality), the device may determine to begin rendering content from the mobile stream (in state 94). In doing so, the device may enable functionality to perform transport-level operations on the demodulated mobile stream, which may comprise a mobile transport stream. (For example, the device may utilize a transport stream processor, such as shown in the examples of FIGS. 2-3, to process the mobile transport stream.) The device may also enable functionality to decode the mobile content after the mobile transport stream has been processed by the transport stream processor to generate one or more elementary streams.

FIG. 6 is a state diagram illustrating an example of state transitions based upon events that determine whether a mobile communication device will switch from rendering content contained in a terrestrial broadcast stream to, instead, rendering content contained in a mobile broadcast stream. In FIG. 6, it is assumed that the device is initially rendering terrestrial content from a received terrestrial broadcast stream (in state 96). For purposes of illustration only, it will be assumed that mobile communication device 2B manages the exemplary state transitions shown in FIG. 6, although any of the other communication devices shown in FIGS. 1-2 may also manage these state transitions.

Though mobile communication device 2B may be rendering terrestrial content, device 2B may determine that, at a certain point during processing, that the signal quality of the terrestrial broadcast stream may fall below a determined, acceptable quality threshold. For example, device 2B may utilize a stream switchover module (such as any of the stream switchover modules shown in FIGS. 1-3) to determine a receive quality of the terrestrial stream by using one or more receiver metrics provided by tuner/demodulator 60, such as metrics for RSSI, MFER, and/or BER. In one scenario, stream switchover module 4B may determine that the received terrestrial stream may have a low RSSI or high BER, indicating a low signal quality.

Additionally, stream switchover module 4B may determine that the signal quality of the received mobile broadcast stream may be of high quality, exceeding a determined quality threshold for the mobile signal. In this case, device 2B may move into state 100, and begin the process of “folding down” (or switching from one stream to another). Device 2B may be considered to begin a “folding down” process, in this example, because it has begun the process of switching from a higher-resolution/frame rate stream (terrestrial stream) to a lower-resolution/frame rate stream (mobile stream).

As shown in FIG. 6, when moving from state 96 to state 100, stream switchover module 2B of the device may enable the processing of the mobile transport stream (in demodulated form). For example, stream switchover module 2B may enable tuner/demodulator 60 to send the mobile transport stream, shown in FIG. 3, to transport stream processor 62 for processing. In some cases, when device 2B is rendering terrestrial content (in state 96), stream switchover module 4B may completely disable the processing of any data from a mobile transport stream. In these cases, tuner/demodulator 60 may not demodulate the incoming mobile broadcast stream or provide a demodulated mobile transport stream to transport stream processor, in an effort to reduce power consumption of device 2B. However, when moving from state 96 to state 100 in FIG. 6, stream switchover module 4B may enable the processing of the mobile transport stream by transport stream processor 62 during a first phase of “folding down,” or switching, to the mobile stream.

Once in state 100, stream switchover module 4B may again start a timer, which may have a preconfigured or determined (e.g., programmable) value. The timer is used when monitoring one or more quality aspects of the processed signals. While the timer is running, stream switchover module 4B may continually monitor the quality of the mobile transport stream as the stream is being processed by transport stream processor 62. For example, stream switchover module 4B may obtain one or more stream metrics from transport stream processor 62 (e.g., TSERR), which stream switchover module 4B may use to determine if the mobile transport stream has a quality that exceeds a defined threshold value. In some cases, stream switchover module 4B may utilize a first group of quality threshold values when monitoring receiver metrics (provided by tuner/demodulator 60) and a second, different group of quality values when monitoring stream metrics (provided by transport stream processor 62).

If the timer expires prior to stream switchover module 4B determining that the quality of the mobile transport stream exceeds a defined threshold, device 2B may re-start the timer and remain in state 100, given that the quality of the mobile stream is not high enough to provide stream data (e.g., elementary stream data) to time-shift buffer 64 and media processors 66. By refraining from time-shifting and/or decoding any of the mobile stream data when the quality of the mobile transport stream fails to exceed a certain threshold, device 2B achieves certain power savings.

If, during state 100, stream switchover module 4B determines, from the receiver metrics provided by tuner/demodulator 60, that the quality of the received terrestrial broadcast stream exceeds a defined threshold, and is therefore of sufficiently high quality, stream switchover module 4B may cancel the timer, and disable the processing of mobile transport stream data by transport stream processor 62. For example, stream switchover module 4B may determine that the received terrestrial stream has high quality based upon a high RSSI value and/or a low BER value. Because the quality of the terrestrial stream has increased to an acceptable level in this case, device 2B may decide to return to state 96 and render terrestrial content from the terrestrial stream. Device 2B may disable any further processing of the mobile transport stream data to achieve power savings.

When device 2B remains in state 100, however, stream switchover module 4B may determine that a measured quality of the mobile transport stream is high (e.g., exceeds a defined threshold), such as when monitoring one or more of the stream metrics (e.g., TSERR) provided by transport stream processor 62, device 2B may move from state 100 to state 102, which comprises a second stage of “folding down” the processing from the terrestrial stream to the mobile stream.

Once in state 102, stream switchover module 4B may enable the decoding functionality for the mobile stream. For example, stream switchover module 4B may enable transport stream processor 62 to provide the PESs for the mobile stream from transport stream processor 62 to time-shift buffer 64 and to media processors 66 for decoding. Prior to moving into state 102, such functionality may be disabled for purposes of power savings within device 2B, such that transport stream processor 62 does not even provide this data from the mobile stream to time-shift buffer 64 or media processors 66.

After device 2B has moved into state 102, stream switchover module 4B may start a second timer, which may comprise a preconfigured or programmable timer used when monitoring one or more quality aspects of the processed signals. If, during state 102, stream switchover module 4B determines, from the receiver metrics provided by tuner/demodulator 60, that the quality of the received terrestrial broadcast stream exceeds a defined threshold, and is therefore of high quality, stream switchover module 4B may cancel the timer, disable the processing of mobile transport stream data by transport stream processor 62, and also disable the decoding of the mobile content by media processors 66. Because the quality of the terrestrial stream has increased to an acceptable level in this case, device 2B may decide to return to state 96 and render terrestrial content from the terrestrial stream. Device 2B may, in some cases, disable any further processing of the mobile transport stream data to achieve power savings.

If stream switchover module 4B determines, from the media or packet-level metrics (e.g., FRERR) provided by media processors 66, that the quality of the decoded mobile content is sufficiently high (e.g., low FRERR), such that the quality exceeds a defined threshold, stream switchover module 4B may move device 2B into state 94 and render the mobile content. Upon moving into state 94, stream switchover module 4B has fully switched the processing from the terrestrial broadcast stream to the mobile broadcast stream, such that device 2B may render and display the mobile content represented by the mobile stream to a ser on one or more of render devices 72.

In one example, stream switchover module 4B may perform a synchronization function when switching from the terrestrial stream to the mobile stream. For instance, in some cases, the mobile stream may have a lower system or network latency, when broadcast, than the terrestrial stream. When switching from the terrestrial stream to the mobile stream, stream switchover module 4B selects a point in time-shift buffer (e.g., time-shift buffer 48 of FIG. 2 or time-shift buffer 64 of FIG. 3), which delays the mobile stream to match the network latency between the streams, to align with the terrestrial stream. The latency value may be transmitted with the broadcast stream or pre-stored in non-volatile memory (in some instances) for use by the time-shift buffer.

The example of FIG. 6 shows various states 96, 100, 102, and 94, where device 2B renders terrestrial content in state 96, and where device 2B renders mobile content in state 94. In this particular example, although device 2B may move into states 100 or 102 at various points in time, device 2B will continue to actually render terrestrial content while in states 100 and 102. In the example, device 2B may not switch from processing the terrestrial content to processing the mobile content until device has moved into state 94. This simultaneous processing of different streams of different data rate and/or resolution may increase processing power, but may also improve the switchover time.

FIG. 7 is a state diagram illustrating an example of state transitions based upon events that determine whether a mobile communication device will switch from rendering content contained in a mobile broadcast stream to, instead, rendering content contained in a terrestrial broadcast stream. In FIG. 7, it is assumed that the device is initially rendering mobile content from a received mobile broadcast stream (in state 94). For purposes of illustration only, it will be assumed that mobile communication device 2B manages the exemplary state transitions shown in FIG. 7, although any of the other communication devices shown in FIGS. 1-2 may also manage these state transitions.

The state transitions and event flow of FIG. 7 are analogous to those shown in FIG. 6, except that device 2B is “folding up” from the processing of lower-resolution/frame rate mobile content to the processing of higher-resolution/frame rate terrestrial content. Thus, device 2B may move from state 94 to state 104 if stream switchover module 4B determines that the quality of the received mobile stream is high or low, but the quality of the received terrestrial stream is high. Because the higher resolution terrestrial content is more desirable to the user, the folding up decision process may, in some cases, be biased to favor terrestrial content irrespective of the state of the initial mobile content. However, in order to minimize power requirements of simultaneously processing both mobile and terrestrial content, the state of the terrestrial signal may only be checked occasionally once it is measured to be of poor quality. In this case, stream switchover module 4B may enable the processing of the terrestrial transport stream that is provided by tuner/demodulator 60 to transport stream processor 62.

Device 2B may move from state 104 to state 106 if stream switchover module 4B determines that the quality of the terrestrial transport stream is high. In this case, stream switchover module 4B may enable the decoding functionality of the elementary streams for the terrestrial content provided by media processors 66, and enable transport stream processor 62 to provide the elementary stream and other data (e.g., PESs, shown in FIG. 3) to media processors 66.

If, in either state 104 or state 106, stream switchover module 4B determines that the quality of the mobile broadcast stream received by tuner/demodulator 60 is of sufficiently (or acceptably) high quality, stream switchover module 4B may cause device 2B to return to state 94, and may also disable the decoding of terrestrial content by media processors 66 and/or the processing of the terrestrial transport stream by transport stream processor 62 in order to conserve power within device 2B.

However, if, in state 106, stream switchover module 4B does not detect a high quality of the received mobile stream, or does determine that the quality of the decoded terrestrial content from media processors 66 exceeds a defined threshold, stream switchover module 4B may switch from processing the mobile content represented in the mobile stream to processing the terrestrial content represented in the terrestrial stream.

In some cases, stream switchover module 4B may disable certain functionality related to the mobile stream upon moving to state 96. For example, in these cases, stream switchover module 4B may disable the decoding functions for the mobile content provided by media processors 66 and/or the transport stream functions for the mobile transport stream provided by transport stream processor 62, in order to achieve power savings within the processing pipeline of device 2B.

The example of FIG. 7 shows various states 94, 104, 106, and 96, where device 2B renders mobile content in state 94, and where device 2B renders terrestrial content in state 96. In this particular example, although device 2B may move into states 104 or 106 at various points in time, device 2B will continue to actually render mobile content while in states 104 and 106. In the example, device 2B may not switch from processing the mobile content to processing the terrestrial content until device has moved into state 96.

In one alternate embodiment (not shown), device 2B may move directly to state 96 and render terrestrial content as soon as stream switchover module 4B determines that the quality of the terrestrial broadcast stream received by tuner/demodulator 60 is high (e.g., exceeds an acceptable threshold). In this alternate embodiment, device 2B may determine to switch directly to state 96 in this condition due to the higher resolution (and frame rate) of the content provided by the terrestrial broadcast stream.

The techniques described in this disclosure may be implemented within one or more of a general purpose microprocessor, digital signal processor (DSP), application specific integrated circuit (ASIC), field programmable gate array (FPGA), programmable logic devices (PLDs), or other equivalent logic devices. Accordingly, the terms “processor” or “controller,” as used herein, may refer to any one or more of the foregoing structures or any other structure suitable for implementation of the techniques described herein.

The various components illustrated herein may be realized by any suitable combination of hardware, software, firmware, or any combination thereof. In the figures, various components are depicted as separate units or modules. However, all or several of the various components described with reference to these figures may be integrated into combined units or modules within common hardware, firmware, and/or software. Accordingly, the representation of features as components, units or modules is intended to highlight particular functional features for ease of illustration, and does not necessarily require realization of such features by separate hardware, firmware, or software components. In some cases, various units may be implemented as programmable processes performed by one or more processors.

Any features described herein as modules, devices, or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices, and may be used in any of a variety of image, display, audio, or other multi-media applications and devices. In some aspects, for example, such components may form part of a mobile device, such as a wireless communication device handset.

If implemented in software, the techniques may be realized at least in part by a computer-readable data storage medium comprising code with instructions that, when executed by one or more processors, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media. Any software that is utilized may be executed by one or more processors, such as one or more DSP's, general purpose microprocessors, ASICs, FPGAs, or other equivalent integrated or discrete logic circuitry.

Various aspects have been described in this disclosure. These and other aspects are within the scope of the following claims.

1. A method comprising:
processing, within a processing pipeline of a communication device, a first broadcast stream representing a first version of media content, wherein the processing pipeline includes a plurality of quality checkpoints at which broadcast stream quality may be determined;
receiving, within the processing pipeline, a second, different broadcast stream that is broadcasted at a different data rate than the first broadcast stream, wherein the second broadcast stream represents a second version of the media content of different media quality than the first version of the media content;
measuring, within the processing pipeline, a quality of the first broadcast stream and a quality of the second broadcast stream at one or more of the quality checkpoints; and
switching the processing from the first broadcast stream to the second broadcast stream if the quality of the second broadcast stream exceeds a defined threshold at one or more of the quality checkpoints.

2. The method of claim 1, further comprising:
rendering the first version of the media content represented by the first broadcast stream prior to switching the processing from the first broadcast stream to the second broadcast stream; and
rendering the second version of the media content represented by the second broadcast stream after the processing has switched from the first broadcast stream to the second broadcast stream.

3. The method of claim 1, further comprising:
storing either or both of the first broadcast stream and the second broadcast stream into memory.

4. The method of claim 1, wherein the second version of the media content has a higher media quality than the first version of the media content.

5. The method of claim 1, wherein switching the processing from the first broadcast stream to the second broadcast stream comprises switching from the first version of the media content to the second version of the media content while compensating for network latency that exists between the first broadcast stream and the second broadcast stream in order to present substantially continuous content.

6. The method of claim 5, further comprising storing an estimated or received network latency time value, and wherein switching from the first version of the media content to the second version of the media content utilizes time shifting to compensate for the network latency when performing the switch.

7. The method of claim 1, further comprising measuring qualities of the first broadcast stream and qualities of the second broadcast stream at one or more of the quality checkpoints to generate a set of quality metrics for the first broadcast stream and the second broadcast stream.

8. The method of claim 7, further comprising providing the set of quality metrics as input to a stream switchover module, and wherein switching the processing from the first broadcast stream to the second broadcast stream comprises using the set of quality metrics by the stream switchover module to determine whether to switch the processing either automatically or under guidance of a user.

9. The method of claim 7, wherein generating the set of quality metrics comprises:
processing one or both of the first and second broadcast streams at multiple ones of the quality checkpoints; and
measuring the qualities of one or both of the first and second broadcast streams at the multiple ones of the quality checkpoints.

10. The method of claim 1, further comprising:
demultiplexing the second broadcast stream;
measuring a quality of the demultiplexed broadcast stream at one of the quality checkpoints;
decoding the demultiplexed broadcast stream; and
measuring a quality of the decoded broadcast stream at another one of the quality checkpoints.

11. The method of claim 1, wherein after the processing has switched from the first broadcast stream to the second broadcast stream, the method further comprises disabling a demultiplexing and a decoding of the first version of the media content represented by the first broadcast stream.

12. A computer-readable storage medium comprising computer-executable instructions for causing one or more processors to:
process, within a processing pipeline, a first broadcast stream representing a first version of media content, wherein the processing pipeline includes a plurality of quality checkpoints at which broadcast stream quality may be determined;
receive, within the processing pipeline, a second, different broadcast stream that is broadcasted at a different data rate than the first broadcast stream, wherein the second broadcast stream represents a second version of the media content of different media quality than the first version of the media content;
measure, within the processing pipeline, a quality of the first broadcast stream and a quality of the second broadcast stream at one or more of the quality checkpoints; and
switch the processing from the first broadcast stream to the second broadcast stream if the quality of the second broadcast stream exceeds a defined threshold at one or more of the quality checkpoints.

13. The computer-readable storage medium of claim 12, further comprising instructions to:
store either or both of the first broadcast stream and the second broadcast stream into memory.

14. The computer-readable storage medium of claim 12, further comprising instructions to:
render the first version of the media content represented by the first broadcast stream prior to switching the processing from the first broadcast stream to the second broadcast stream; and
render the second version of the media content represented by the second broadcast stream after the processing has switched from the first broadcast stream to the second broadcast stream.

15. The computer-readable storage medium of claim 12, wherein the second version of the media content has a higher media quality than the first version of the media content.

16. The computer-readable storage medium of claim 12, wherein the instructions to switch the processing from the first broadcast stream to the second broadcast stream comprise instructions to switch from the first version of the media content to the second version of the media content to compensate for network latency that exists between the first broadcast stream and the second broadcast stream in order to present substantially continuous content.

17. The computer-readable storage medium of claim 16, further comprising instructions to store an estimated or received network latency time value, wherein the instructions to switch from the first version of the media content to the second version of the media content comprise instructions to utilize time-shifting to compensate for network latency when performing the switch.

18. The computer-readable storage medium of claim 12, further comprising instructions to measure qualities of the first broadcast stream and qualities of the second broadcast stream at one or more of the quality checkpoints to generate a set of quality metrics for the first broadcast stream and the second broadcast stream.

19. The computer-readable storage medium of claim 18, further comprising instructions to provide the set of quality metrics as input to a stream switchover module, and wherein the instructions to switch the processing from the first broadcast stream to the second broadcast stream comprise instructions to use the set of quality metrics by the stream switchover module to determine whether to switch the processing either automatically or under guidance of a user.

20. The computer-readable storage medium of claim 18, wherein the instructions to generate the set of quality metrics comprise instructions to:
process one or both of the first and second broadcast streams at multiple ones of the quality checkpoints; and
measure the qualities of one or both of the first and second broadcast streams at the multiple ones of the quality checkpoints.

21. The computer-readable storage medium of claim 12, further comprising instructions to:
demultiplex the second broadcast stream;
measure a quality of the demultiplexed broadcast stream at one of the quality checkpoints;
decode the demultiplexed broadcast stream; and
measure a quality of the decoded broadcast stream at another one of the quality checkpoints.

22. The computer-readable storage medium of claim 12, further comprising instructions to disable a demultiplexing and a decoding of the first version of the media content represented by the first broadcast stream after the processing has switched from the first broadcast stream to the second broadcast stream.

23. A communication device, comprising:
a processing pipeline comprising one or more processors, wherein the processing pipeline includes a plurality of quality checkpoints at which broadcast stream quality for one or more broadcast streams may be determined, and
wherein the one or more processors of the processing pipeline are configured to:
process a first broadcast stream representing a first version of media content;
receive a second, different broadcast stream that is broadcasted at a different data rate than the first broadcast stream, wherein the second broadcast stream represents a second version of the media content of different media quality than the first version of the media content;
measure a quality of the first broadcast stream and a quality of the second broadcast stream at one or more of the quality checkpoints; and
switch the processing from the first broadcast stream to the second broadcast stream if the quality of the second broadcast stream exceeds a defined threshold at one or more of the quality checkpoints.

24. The communication device of claim 23, further comprising one or more memory devices, wherein the one or more processors are further configured to store either or both of the first broadcast stream and the second broadcast stream into the one or more memory devices.

25. The communication device of claim 23, further comprising a display device, wherein the one or more processors are further configured to render, for display on the display device, the first version of the media content represented by the first broadcast stream prior to switching the processing from the first broadcast stream to the second broadcast stream, and wherein the one or more processors are further configured to render, for display on the display device, the second version of the media content represented by the second broadcast stream after the processing has switched from the first broadcast stream to the second broadcast stream.

26. The communication device of claim 23, wherein the second version of the media content has a higher media quality than the first version of the media content.

27. The communication device of claim 23, wherein the one or more processors are configured to switch the processing from the first broadcast stream to the second broadcast stream at least by switching from the first version of the media content to the second version of the media content while compensating for network latency that exists between the first broadcast stream and the second broadcast stream in order to present substantially continuous content.

28. The communication device of claim 27, further comprising a time-shift buffer, wherein the one or more processors are configured to store an estimated or received network latency time value and to switch from the first version of the media content to the second version of the media content based upon the network latency at least by utilizing time shifting to compensate for the network latency when performing the switch.

29. The communication device of claim 23, wherein the one or more processors are configured to measure qualities of the first broadcast stream and qualities of the second broadcast stream at one or more of the quality checkpoints to generate a set of quality metrics for the first broadcast stream and the second broadcast stream.

30. The communication device of claim 29, wherein the one or more processors further are configured to provide the set of quality metrics as input to a stream switchover module, and wherein the one or more processors are configured to switch the processing from the first broadcast stream to the second broadcast stream at least by using the set of quality metrics by the stream switchover module to determine whether to switch the processing either automatically or under guidance of a user.

31. The communication device of claim 29, wherein the one or more processors are configured to generate the set of quality metrics at least by processing one or both of the first and second broadcast streams at multiple ones of the quality checkpoints, and measuring the qualities of one or both of the first and second broadcast streams at the multiple ones of the quality checkpoints.

32. The communication device of claim 23, wherein the one or more processors are further configured to:
demultiplex the second broadcast stream;
measure a quality of the demultiplexed broadcast stream at one of the quality checkpoints;
decode the demultiplexed broadcast stream; and
measure a quality of the decoded broadcast stream at another one of the quality checkpoints.

33. The communication device of claim 23, wherein the one or more processors are further configured to disable a demultiplexing and a decoding of the first version of the media content represented by the first broadcast stream after the processing has switched from the first broadcast stream to the second broadcast stream.

34. The communication device of claim 23, wherein the communication device comprises a wireless communication device handset.

35. The communication device of claim 23, wherein the communication device comprises one or more integrated circuit devices.

36. A communication device, comprising:
means for processing, within a processing pipeline, a first broadcast stream representing a first version of media content, wherein the processing pipeline includes a plurality of quality checkpoints at which broadcast stream quality may be determined;
means for receiving, within the processing pipeline, a second, different broadcast stream that is broadcasted at a different data rate than the first broadcast stream, wherein the second broadcast stream represents a second version of the media content of different media quality than the first version of the media content;
means for measuring, within the processing pipeline, a quality of the first broadcast stream and a quality of the second broadcast stream at one or more of the quality checkpoints; and
means for switching the processing from the first broadcast stream to the second broadcast stream if the quality of the second broadcast stream exceeds a defined threshold at one or more of the quality checkpoints.

37. The communication device of claim 36, further comprising:
means for storing either or both of the first broadcast stream and the second broadcast stream.

38. The communication device of claim 36, further comprising:
means for rendering the first version of the media content represented by the first broadcast stream prior to switching the processing from the first broadcast stream to the second broadcast stream; and
means for rendering the second version of the media content represented by the second broadcast stream after the processing has switched from the first broadcast stream to the second broadcast stream.

39. The communication device of claim 36, wherein the second version of the media content has a higher media quality than the first version of the media content.

40. The communication device of claim 36, wherein the means for switching the processing from the first broadcast stream to the second broadcast stream comprises means for switching from the first version of the media content to the second version of the media content while compensating for network latency that exists between the first broadcast stream and the second broadcast stream in order to present substantially continuous content.

41. The communication device of claim 40, further comprising means for storing an estimated or received network latency time value, wherein the means for switching from the first version of the media content to the second version of the media content based upon the network latency comprises means for utilizing time shifting to compensate for the network latency when performing the switch.

42. The communication device of claim 36, wherein the means for measuring qualities of the first broadcast stream and qualities of the second broadcast stream at one or more of the quality checkpoints to generate a set of quality metrics for the first broadcast stream and the second broadcast stream.

43. The communication device of claim 42, further comprising means for providing the set of quality metrics as input to a stream switchover module, and wherein the means for switching the processing from the first broadcast stream to the second broadcast stream comprises means for using the set of quality metrics by the stream switchover module to determine whether to switch the processing either automatically or under guidance of a user.

44. The communication device of claim 42, wherein the means for generating the set of quality metrics comprises:
means for processing one or both of the first and second broadcast streams at multiple ones of the quality checkpoints; and
means for measuring the qualities of one or both of the first and second broadcast streams at the multiple ones of the quality checkpoints.

45. The communication device of claim 36, further comprising:
means for demultiplexing the second broadcast stream;
means for measuring a quality of the demultiplexed broadcast stream at one of the quality checkpoints;
means for decoding the demultiplexed broadcast stream; and
means for measuring a quality of the decoded broadcast stream at another one of the quality checkpoints.

46. The communication device of claim 36, further comprising means for disabling a demultiplexing and a decoding of the first version of the media content represented by the first broadcast stream after the processing has switched from the first broadcast stream to the second broadcast stream.
